(19) United States
(12) Patent Application Publication
(10) Pub. No.: US 2004/0222261 A1
(43) Pub. Date: Nov. 11, 2004

(54) Drop-down tire carrier

(76) Inventor: Ryan Wilson, San Marcos, CA (US)

Correspondence Address: D. Whitlow Bivens, Esq., Musick, Peeler & Garrett LLP, Suite 1900, 225 Broadway, San Diego, CA, 92101, US

(21) Appl. No.: 10/842,114

(22) Filed: May 10, 2004

Related U.S. Application Data
(60) Provisional application No. 60/469,290, filed on May 9, 2003.

(51) Int. Cl. B62D 43/00; B60R 9/00; B60R 11/00

(52) U.S. Cl. 224/509; 224/42.21; 224/42.24

(57) ABSTRACT

An exterior-mounted spare wheel carrier for a vehicle. The carrier is capable of rotating about a substantially horizontal axis and a substantially vertical axis to allow the spare wheel to be lowered to a position proximate the ground to facilitate the changing of a vehicle's wheel. The spare wheel carrier is releasably secured in a substantially horizontal plane by a tension member. The rotation of spare wheel carrier about a substantially vertical axis is governed by a governing mechanism. The spare wheel carrier is releasably held in a traveling position by an engaging mechanism and a safety latch.

### CLAIM OF PRIORITY

This application is a continuation-in-part application and claims priority from and the benefit of U.S. Provisional Application No. 60/469,290 titled Drop-down tire carrier filed May 9, 2003.

### BACKGROUND OF THE INVENTION

1. Field of the Invention

The invention generally relates to an apparatus for carrying a spare wheel and tire (hereinafter referred to as a “spare wheel”) on the exterior of a vehicle. Such exterior spare wheel carriers are advantageous as they preserve interior vehicle space by locating the spare wheel on the exterior of the vehicle rather than somewhere inside the vehicle. Such exterior wheel carriers may be found on vehicles designed for off-road use. Frequently, the spare wheels of such vehicles are significantly larger and heavier than the spare wheels of a conventional automobile. The increased size and weight of such spare wheels can make changing a wheel a difficult or impossible task for a single person.

2. Prior Art

U.S. patent application Ser. No. 09/951,220 discloses a bumper-mounted spare wheel carrier capable of lowering the spare wheel to the ground while the spare wheel is attached to the carrier. The raising and lowering of the spare wheel is facilitated by an arm actuator which may include oppositely threaded shafts mounted within a threaded sleeve and a ratchet drive mechanism to rotate the sleeve with respect to the shafts. Alternatively, the actuator may be an electrically powered linear actuator.

### SUMMARY OF THE INVENTION

The present invention comprises an exterior-mounted spare wheel carrier that facilitates the changing of a wheel by allowing the wheel to be lowered from the carrying position to a position proximate to the ground. The spare wheel carrier is capable of pivoting about a substantially vertical axis to allow the spare wheel to be swung away from the vehicle allowing access to the rear door or doors of the vehicle. The spare wheel carrier is also capable of pivoting about a substantially horizontal axis to allow the spare wheel to be lowered to or raised from a position proximate to the ground. Such raising and lowering facilitates the changing of a wheel.

In one embodiment of the invention, the spare wheel carrier comprises a main horizontal support. A horizontal pivot mechanism allowing rotation about a substantially vertical axis is located at a pivoting end of the main horizontal support and rotatably attaches the main horizontal support to the rear of the vehicle. The pivot mechanism may be attached to the bumper of the vehicle or to some other location. Such attachment may be accomplished by an attachment plate that may be attached to the vehicle bumper or other suitable locations by bolts, welding, or other known attachment means.

In certain embodiments of the invention, the rotation of the spare wheel carrier about the substantially vertical axis is governed by a governing mechanism. In certain embodiments of the invention, the governing mechanism may both dampen and assists the rotation of the spare wheel carrier about the substantially vertical axis depending on the degree to which the main horizontal support has been rotated away from the resting position of the main horizontal support when such support is engaged for travel as described below. Alternatively, the governing mechanism may only dampen the rotation or only assist the rotation. In any embodiment, the governing mechanism will control the speed of rotation of the spare wheel carrier about the substantially vertical axis to reduce the chance of accident, damage or injury due to the spare wheel carrier swinging open or closed in an uncontrolled manner.

In one embodiment of the invention, one end of the governing mechanism may be releasably attached to the main horizontal support. The other end of the governing mechanism may be releasably attached to the bumper of the vehicle or the attachment plate of the spare wheel carrier.

The wheel carrier is engaged for travel by means of an engaging mechanism which releasably holds the wheel carrier to the rear of the vehicle. The engaging mechanism may be located to engage the end of the main horizontal support distal to the pivot mechanism. Alternatively, the engagement mechanism may be located to engage the main horizontal support at some point on the main horizontal support other than the distal end. The engaging mechanism releasably engages the engaging end or other portion of the main horizontal support to secure the wheel carrier for travel. Such engagement may be accomplished by the engaging mechanism engaging the main horizontal support directly or it may be accomplished by the engaging mechanism engaging a component attached to the main horizontal support. In some embodiments of the invention, a safety catch may be provided to keep the main horizontal support secured in the travel position in the event that the engaging mechanism fails.

In one embodiment of the invention the pivoting end of the main horizontal support also is attached to a vertical pivot mechanism allowing rotation about a substantially horizontal axis to allow the spare wheel to be raised and lowered while the wheel is still attached to the wheel carrier.

In one embodiment of the invention at least one vertical support extends generally upwards and generally perpendicularly away from the main horizontal support. Means for securing the spare wheel to the wheel carrier may be located on the vertical support to position the spare wheel at an appropriate location to allow travel when the spare wheel carrier is secured for traveling and to minimize the distance between the bottom of the wheel and the ground when the wheel carrier is in the lowered position. Additional supports may be added to further reinforce the vertical support and assist in supporting the spare wheel when it is attached to the vertical support. The center of the spare wheel may be located at approximately equal distances from each end of the main horizontal support. Such a location minimizes the torque exerted on the horizontal pivot mechanism and the engaging mechanism.

The means for attaching the spare wheel may be selected from any known means. In one embodiment of the invention, the means for attaching the spare wheel comprises a short post extending in a generally horizontal direction perpendicularly away from the vertical support. A plate with at least one bolt or other attachment means for attaching the spare wheel to the plate is located at the opposite end of the post.

The spare wheel carrier is releasably held at a predetermined horizontal level by a tension member. In one embodiment of the invention, a first end of the tension member may be secured to or secured proximate to the horizontal pivot mechanism and the vertical pivot mechanism such that it may pivot about a substantially vertical axis in tandem with the horizontal pivoting of the main horizontal support. A second end of the tension member may be secured to the vertical support or to any additional supports that reinforce the vertical support. Preferably, the tension member is capable of pivoting in a substantially horizontal plane about a substantially vertical axis along with the main horizontal support. Preferably, the tension member also is capable of pivoting in a substantially vertical plane about a substantially horizontal axis. Such horizontal pivoting ability may be accomplished by attaching the pivoting end of the tension member to the horizontal pivot mechanism of the main horizontal support. Alternatively, the tension member may have an independent horizontal pivot mechanism. Likewise, the tension member's vertical pivoting ability may be provided by attaching the pivoting end of the tension member to the vertical pivot mechanism of the main horizontal support. Alternatively, the tension member may have an independent horizontal and/or vertical pivot mechanism. In its engaged state, the tension member holds the spare wheel carrier in a substantially horizontal plane regardless of whether the main horizontal support is engaged by the engagement mechanism.

In one embodiment of the invention, the tension member and the governing mechanism are capable of being modified to a disengaged state which allows the spare wheel carrier to be lowered and raised with respect to the ground. With respect to the tension member, such a disengaged state may be accomplished by disengaging at least one end of the tension member. Alternatively, the disengaged state of the tension member may be accomplished by disengaging one portion of the tension member from the remaining portion of the tension member at some point along the length of the tension member. When the tension member is disengaged, the main horizontal member is not engaged to the engaging mechanism, and the governing mechanism is disengaged, a user may raise and lower the wheel carrier by pivoting the wheel carrier in a vertical direction about a substantially horizontal axis.

In one embodiment of the invention, one end of the tension member is removably secured by means of a removable pin passing through an opening in the tension member and an opening in the component to which the tension member is attached. When the pin is in place, the tension member is secured at both ends and holds the spare wheel carrier in a substantially horizontal plane. When the pin is removed, the tension member is disengaged and the spare wheel carrier is free to pivot vertically about a substantially horizontal axis to allow the spare wheel carrier to be raised and lowered with respect to the ground. If the embodiment of the invention at issue includes a governing mechanism that governs the horizontal rotation of the spare wheel carrier about the substantially vertical axis, at least one end of the governing mechanism also is disengaged to allow the spare wheel carrier to be raised and lowered with respect to the ground.

### BRIEF DESCRIPTION OF THE DRAWINGS

FIG. 1 is a perspective view of one embodiment of the spare wheel carrier shown in a traveling state;

FIG. 2 is a perspective view of one embodiment of the spare wheel carrier shown pivoting about a substantially vertical axis with the tension member and governing mechanism engaged;

FIG. 3 is a perspective view of one embodiment of the spare wheel carrier shown pivoting about both a substantially vertical axis and a substantially horizontal axis with the tension member and governing mechanism disengaged;

FIG. 4 is an elevational view of a portion of one embodiment of the spare wheel carrier including the main horizontal support, the vertical support, additional supports, and one means of attaching the spare wheel;

FIG. 5 is a side elevational view showing one embodiment of the main horizontal support's and tension member's vertical and horizontal pivoting mechanisms and one embodiment of the governing mechanism;

FIG. 6 is a front elevational view of one embodiment of the main horizontal support's engagement mechanism and safety catch;

FIG. 6A is a side elevational view of one embodiment of the main horizontal support's engagement mechanism;

FIG. 7 is an elevational view of one embodiment of the tension member;

FIG. 8 is an elevational view of one embodiment of a pin that may removably secure the tension member to a support in one embodiment of the invention;

FIG. 9 is an elevational view of one embodiment of a license plate holder that may be included in an embodiment of the invention;

FIG. 10 is a vertical view taken horizontally along line 10-10; and

FIG. 11 is a side elevational view of one embodiment of the engagement mechanism, a portion of the main horizontal support, and the safety catch.

### DETAILED DESCRIPTION OF THE INVENTION

The following description is of one or more of the presently contemplated modes of carrying out the invention. This description is made for the purposes of illustrating specific applications of the general principles of the invention and should not be taken in a limiting sense.

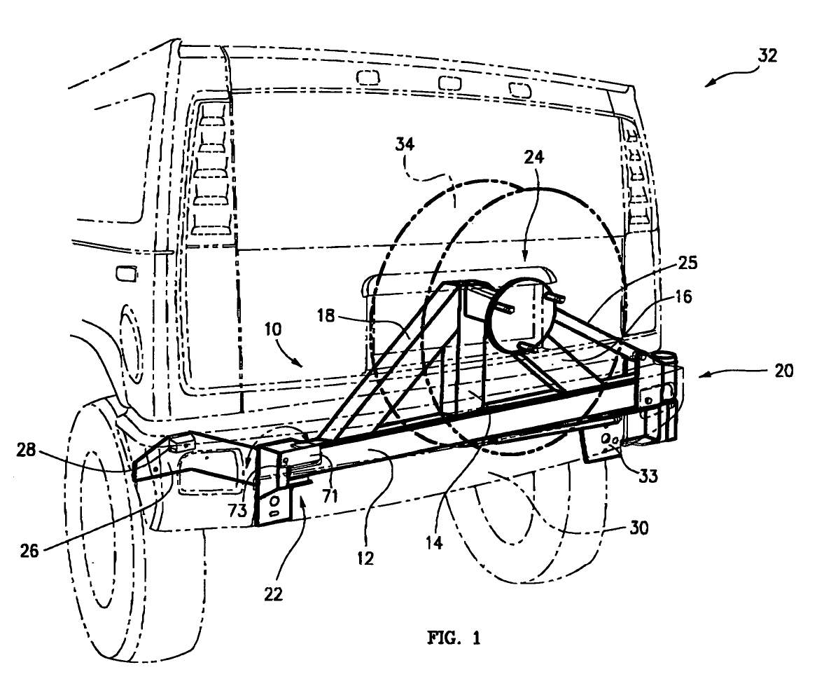

As shown in FIG. 1, one embodiment of the spare wheel carrier generally indicated by the reference number 10 comprises a main horizontal support 12, a vertical support 14, additional supports 16 and 18, a pivoting mechanism indicated generally by the reference number 20, an engaging mechanism indicated generally by the reference number 22, a wheel securing structure indicated generally by the reference number 24, and a tension member 25. Optionally, a license plate holder 26 may be incorporated which may have a light 28 for illuminating the license plate.

The pivoting mechanism 20 may be attached to the bumper 30 of the vehicle 32 by attachment plate 33. The pivoting end of the main horizontal support 12 is attached to pivoting mechanism 20. The engaging mechanism 22 may be located at the end of the main horizontal support distal to the pivoting mechanism 20. The engaging mechanism 22 releasably engages the engaging end or other portion of the main horizontal support 12 to secure the wheel carrier 10 for traveling. In certain embodiments, the tire carrier may include a safety catch generally designated as 69 in FIG. 6. In one embodiment of the invention, safety catch 69 comprises an L-shaped member 71 which pivots about pin 73. Pin 73 may be a bolt, screw, or any other suitable component that will attach member 71 to the receiving portion 68 of engaging mechanism 22.

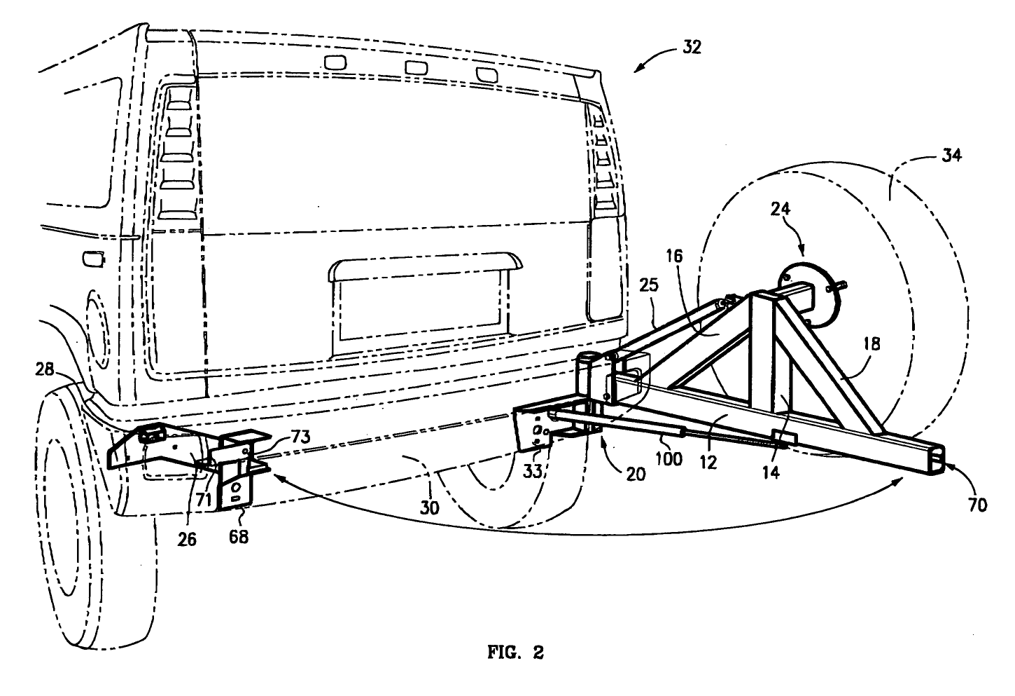

In the preferred embodiment, pivoting mechanism 20 comprises a heavy-duty hinge 44 capable of bearing the weight of wheel carrier 10 and spare wheel 34 and capable of withstanding the resulting torque generated by such weight. As shown in FIGS. 2 and 3, hinge 44 pivots about a substantially vertical axis when installed. Two plates 46 and 48 are attached to hinge 44. Plates 46 and 48 are spaced to receive tension member 25 and main horizontal support 12 between plates 46 and 48. Main horizontal support 12 is rotatably attached to pivoting mechanism 20 by pivot pin 50 which passes through openings collectively numbered 52 in plates 46 and 48 and opening 54 in main horizontal support 12. As shown in FIG. 3, such attachment allows main horizontal support 12 to be raised and lowered relative to the ground, pivoting about a substantially horizontal axis defined by pivot pin 50. Similarly, tension member 25 is attached to pivoting mechanism 20 by pivot pin 56 which passes through openings collectively numbered 58 in plates 46 and 48 and opening 60 in tension member 25. Thus, tension member 25 is also able to pivot about a substantially horizontal axis defined by pivot pin 56.

As shown in FIG. 2, the wheel carrier 12 may be disengaged from the engaging mechanism 22 and swung away from the rear of the vehicle 32. Under such circumstances, the pivoting mechanism 20 allows the wheel carrier to pivot in a substantially horizontal plane about a substantially vertical axis and governing mechanism 100 dampens and/or assists such rotation. One example of a suitable governing mechanism, set forth without the intent of limiting the scope of the invention, is a fixed force gas spring such as part number GGS23-020-I manufactured by H.A. Guden Co.

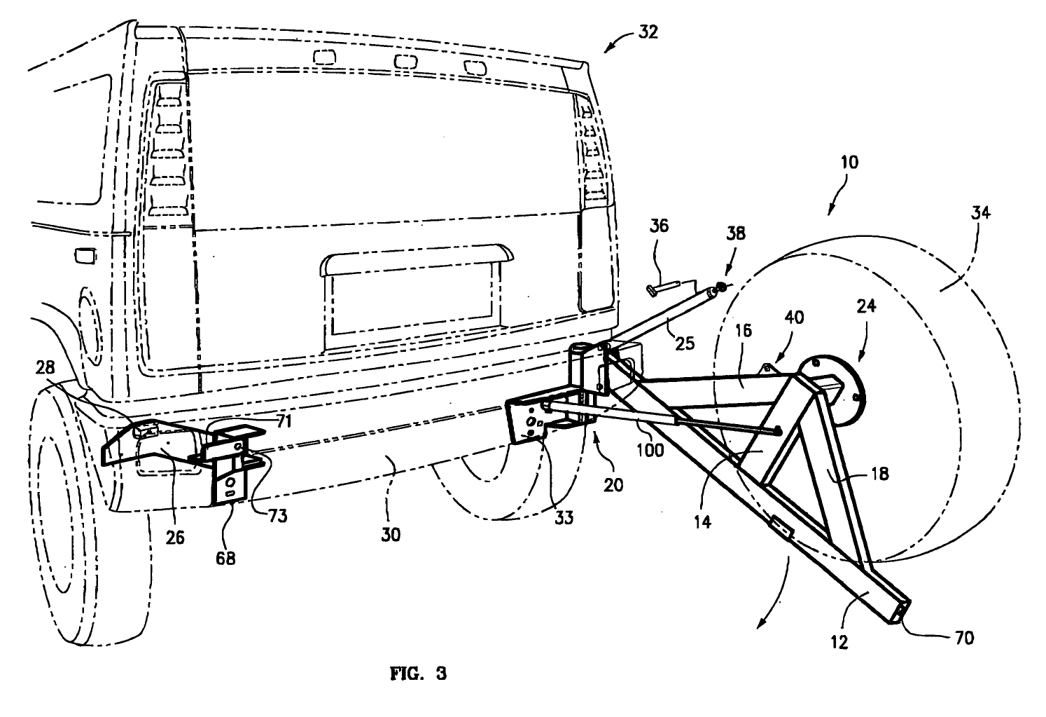

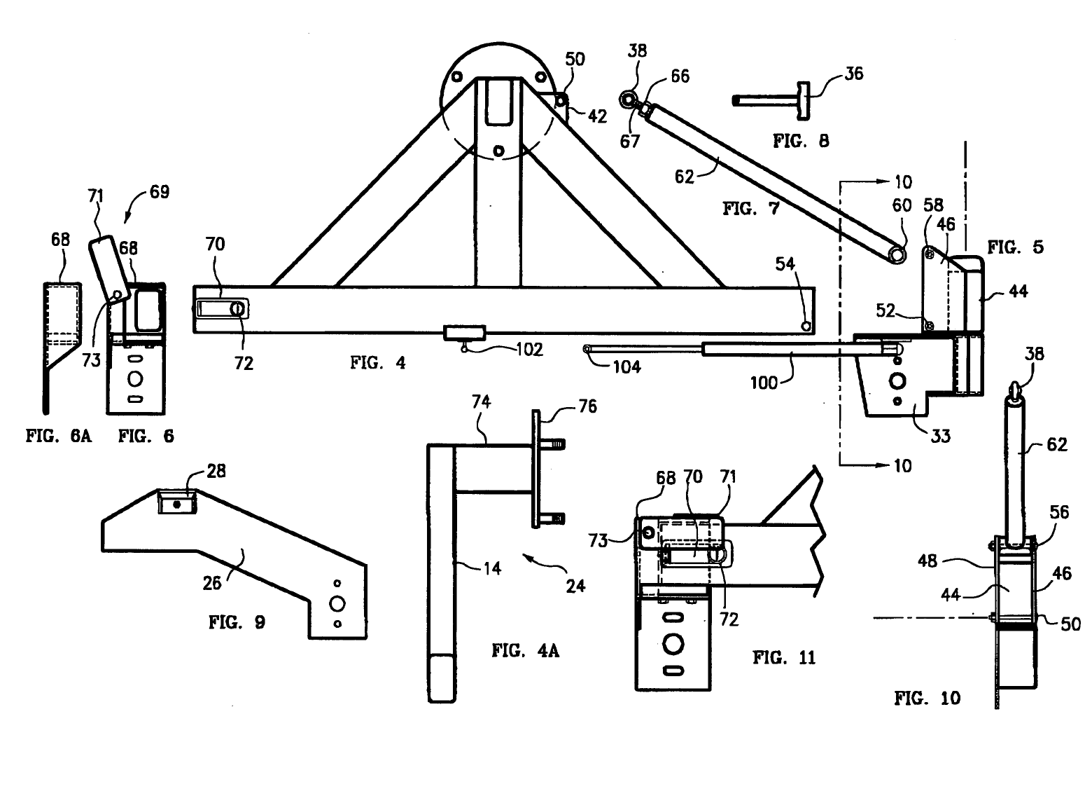

One end of governing mechanism 100 is releasably attached to main horizontal support 12 by ball stud 102 (shown in FIG. 4). One example of a suitable ball stud, set forth without the intent of limiting the scope of the invention, is a ball stud such as part number BS101-02manufactured by H.A. Guden Co. When governing mechanism 100 is releasably attached to main horizontal support 12, ball stud 102 fits into socket 104 at the end of governing mechanism 100. The other end of governing mechanism 100 is attached in an identical manner to attachment plate 33.

As shown in FIG. 3, when tension member 25 and governing mechanism 100 are disengaged, the pivoting mechanism 20 also allows the wheel carrier 10 to pivot in a substantially vertical plane about a substantially horizontal axis to facilitate raising and lowing of spare wheel 34.

The wheel carrier 10 is fixed in a substantially horizontal plane by means of tension member 25. One end of tension member 25 is attached to pivoting mechanism 20. The other end of tension member 25 is removably attached to additional support 16 by removable pin 36. Removable pin 36 removably attaches tension member 25 to additional support 16 by passing through eye 38 at the end of tension member 25 and at least one opening 40 in tab 42 attached to additional support 16. In the preferred embodiment, tab 42 is made up of two tabs spaced to receive eye 38 of tension member 25 between the two tabs 42. Removable pin 36 may be secured in place by known means such as a cotter pin or a depressible ball bearing located within removable pin 36, partially protruding from the surface of removable pin 36, and biased outward from removable pin 36.

In the preferred embodiment, tension member 25 comprises a sleeve 62 the interior of which (not shown) is at least partially threaded, threaded rod 64, and locking nut 66. Threaded rod 64 is at least partially engaged with the interior threads of sleeve 62. The length of tension member 25 may be adjusted by rotating threaded rod relative to sleeve 62. The length of tension member 25 may be fixed by tightening locking nut 66 against sleeve 62. Varying the length of tension member 25 will raise or lower the height of main horizontal support 12 when the tension member is engaged.

In the preferred embodiment, engaging mechanism 22 comprises a receiving portion 68 and an engaging latch 70. The engaging latch 70 is mounted on the engaging end of the main horizontal support and may have a locking mechanism 72 to prevent the latch 70 from opening when the locking mechanism 72 is locked.

In the preferred embodiment, the wheel securing structure 24 comprises a post 74 attached at one end to and extending perpendicularly outward from vertical support 14. Plate 76 is attached to the distal end of post 74 and wheel attaching bolts 78 extend outward from plate 78 to allow the spare wheel to be attached.

One method of using the spare wheel carrier to facilitate the changing of a tire will now be described. It is important to note that the following description is given without intent to limit the scope of the invention and one reasonably skilled in the art will recognize that other methods of using the spare wheel carrier may be employed. As shown in FIG. 1, in the traveling state, the spare wheel carrier is secured to the vehicle by pivot mechanism 20, engaging mechanism 22, and safety catch 69. In preparation for changing one of the vehicle's wheels, L-shaped member 71 is rotated about pin 73 to allow main horizontal support 12 to be disengaged from engaging mechanism 22. Main horizontal support is then disengaged from engaging mechanism 22 and spare wheel carrier 10 is swung away from the vehicle as shown in FIG. 2. Such rotation is governed by governing mechanism 100 to reduce the chance of accident, damage or injury due to the spare wheel carrier swinging in an uncontrolled manner. Next, as shown in FIG. 3, governing mechanism 100 is disengaged from main horizontal support 12 by separating ball stud 102 from socket 104. Removable pin 36 is then removed disengaging tension member 25 from the remainder of the wheel carrier 10. Main horizontal support 12 may then be lowered until its distal end contacts the ground. In such a position, spare wheel 34 will be proximate to the ground. Spare wheel 34 is then removed from the wheel securing structure 24 and carried or rolled to the appropriate location to change the wheel.

Once the flat wheel has been replaced with spare wheel 34, the flat wheel is rolled or carried back to the spare wheel carrier 10 and attached to the wheel securing structure 24. The main horizontal support is the lifted to a position wherein the eye 38 is aligned with openings 40 in tab 42. Removable pin 36 is replaced in openings 40 and eye 38 to secure wheel carrier 10 in a substantially horizontal plane. Governing mechanism 100 is then once again attached to main horizontal support 12 by inserting ball stud 102 into socket 104. Wheel carrier 10 is then secured to vehicle 32 by engagement mechanism 22. Finally, the L-shaped member 71 of safety catch 69 is rotated about pin 73 to further secure main horizontal support 12 to receiving portion 68 of engaging mechanism 22.

Although the invention has been described herein with references to specific embodiments, many modifications, insertions, deletions and variations will readily occur to those reasonably skilled in the art. Accordingly, all such variations and modifications are included within the intended scope of the invention.

What is claimed is:

1. A spare wheel carrier for mounting on the exterior of a vehicle comprising:
one or more pivot mechanisms adapted to be attached to the exterior of a vehicle;
a main horizontal support having a first end attached to said one or more pivot mechanisms wherein said one or more pivot mechanisms enable said main horizontal support to pivot about both a substantially vertical axis and a substantially horizontal axis;
a second support adapted to receive and releasably secure a spare wheel and tire attached to said main horizontal support;
a tension member having an engaged and a disengaged state; and
when said tension member is in said engaged state said tension member has a first end secured to said second support and a second end secured at a location such that said tension member holds said main horizontal support in a substantially horizontal plane during rotation of said main horizontal support about a substantially vertical axis.

2. The spare wheel carrier of claim 1 wherein said first end of said tension member is releasably secured to said second support when said tension member is in said engaged state.

3. The spare wheel carrier of claim 2 wherein said first end of said tension member is releasably secured to said second support by a removable pin.

4. The spare wheel carrier of claim 1 further comprising a governing mechanism having an engaged state and a disengaged state wherein a first end of said governing mechanism is attached to said main horizontal support and a second end of said governing mechanism is attached at a location such that said governing mechanism governs the rotation of said main horizontal support about a substantially vertical axis when said governing mechanism is in said engaged state.

5. The spare wheel carrier of claim 2 further comprising a governing mechanism having an engaged state and a disengaged state wherein a first end of said governing mechanism is attached to said main horizontal support and a second end of said governing mechanism is attached at a location such that said governing mechanism governs the rotation of said main horizontal support about a substantially vertical axis when said governing mechanism is in said engaged state.

6. The spare wheel carrier of claim 3 further comprising a governing mechanism having an engaged state and a disengaged state wherein a first end of said governing mechanism is attached to said main horizontal support and a second end of said governing mechanism is attached at a location such that said governing mechanism governs the rotation of said main horizontal support about a substantially vertical axis when said governing mechanism is in said engaged state.

7. The spare wheel carrier of claim 1 further comprising an engaging mechanism adapted to releasably secure said main horizontal support to said vehicle.

8. The spare wheel carrier of claim 7 wherein said engaging mechanism is located at or proximate to a second end of said main horizontal support opposite said first end of said main horizontal support.

9. The spare wheel carrier of claim 7 wherein said engaging mechanism is lockable.

10. The spare wheel carrier of claim 8 wherein said engaging mechanism is lockable.

11. The spare wheel carrier of claim 1 further comprising a safety catch adapted to releasably secure said main horizontal support to said vehicle.

12. A spare wheel carrier for mounting on the exterior of a vehicle comprising:
one or more pivot mechanisms adapted to be attached to the exterior of a vehicle;
a main horizontal support having a first end attached to said one or more pivot mechanisms wherein said one or more pivot mechanisms enable said main horizontal support to pivot about both a substantially vertical axis and a substantially horizontal axis;
a second support adapted to receive and releasably secure a spare wheel and tire attached to said main horizontal support;
a tension member having an engaged and a disengaged state wherein when said tension member is in said engaged state a first end of said tension member is releasably secured to said second support by a removable pin and a second end of said tension member is secured at a location such that said tension member holds said main horizontal support in a substantially horizontal plane during rotation of said main horizontal support about a substantially vertical axis; and
an engaging mechanism adapted to releasably secure said main horizontal support to said vehicle.

13. The spare wheel carrier of claim 12 further comprising a governing mechanism having an engaged state and a disengaged state wherein a first end of said governing mechanism is attached to said main horizontal support and a second end of said governing mechanism is attached at a location such that said governing mechanism governs the rotation of said main horizontal support about a substantially vertical axis when said governing mechanism is in said engaged state.

14. The spare wheel carrier of claim 12 wherein said engaging mechanism is located at or proximate to a second end of said main horizontal support opposite said first end of said main horizontal support.

15. The spare wheel carrier of claim 12 wherein said engaging mechanism is lockable.

16. The spare wheel carrier of claim 13 wherein said engaging mechanism is located at or proximate to a second end of said main horizontal support opposite said first end of said main horizontal support.

17. The spare wheel carrier of claim 13 wherein said engaging mechanism is lockable.

18. The spare wheel carrier of claim 12 further comprising a safety catch adapted to releasably secure said main horizontal support to said vehicle.

19. The spare wheel carrier of claim 13 further comprising a safety catch adapted to releasably secure said main horizontal support to said vehicle.

20. The spare wheel carrier of claim 14 further comprising a safety catch adapted to releasably secure said main horizontal support to said vehicle.

21. The spare wheel carrier of claim 15 further comprising a safety catch adapted to releasably secure said main horizontal support to said vehicle.

22. The spare wheel carrier of claim 16 further comprising a safety catch adapted to releasably secure said main horizontal support to said vehicle.

23. The spare wheel carrier of claim 17 further comprising a safety catch adapted to releasably secure said main horizontal support to said vehicle.
